(19) United States
(12) Patent Application Publication
(10) Pub. No.: US 2021/0087851 A1
(43) Pub. Date: Mar. 25, 2021

(54) SECURITY SYSTEM FOR A BUILDING

(71) Applicants: Roland Trout, Lexington, NC (US); Stephen Gardner Worth, III, Holly Springs, NC (US); William Neal Davis, Greensboro, NC (US); Eric Michael Wagner, Cary, NC (US); George Lee Reid, Greer, SC (US); Christopher Ryan Leroux, Asheboro, NC (US)

(72) Inventors: Roland Trout, Lexington, NC (US); Stephen Gardner Worth, III, Holly Springs, NC (US); William Neal Davis, Greensboro, NC (US); Eric Michael Wagner, Cary, NC (US); George Lee Reid, Greer, SC (US); Christopher Ryan Leroux, Asheboro, NC (US)

(21) Appl. No.: 16/580,629

(22) Filed: Sep. 24, 2019

(51) Int. Cl. E05B 47/00; E05B 17/00; E05C 19/00

(52) U.S. Cl. CPC E05B 47/0001; E05B 17/0083; E05B 2047/0067; E05B 2047/0068; E05C 19/003

(57) ABSTRACT

A security system for a building includes a plurality of lock modules. Each lock module is associated with a particular door and has an unlocked position and a locked position. Each lock module includes a lock bar, an actuator, and a controller. The lock bar has a first position that allows the particular door to open and a second position that extends from a door frame, a wall, or a floor surface adjacent to the particular door to prevent the particular door from opening. The actuator moves the lock bar between the first and second positions. The controller is operably connected to the actuator and transmits a door status signal that uniquely identifies the particular door. A lock module command signal received by the plurality of lock modules directs the plurality of lock modules to reposition to either the unlocked position or the locked position.

### FIELD OF THE INVENTION

The present invention generally involves a security system for a building. Particular embodiments of the present invention may provide local and/or remote lockdown and/or monitoring capability for multiple doors in the building to control access inside the building.

### BACKGROUND OF THE INVENTION

Schools, airports, dormitories, and virtually all commercial and private buildings often include multiple interior rooms. It is generally necessary to allow students, employees, guests, and other authorized personnel to enter the buildings and freely move between the interior rooms throughout the day. The number of authorized personnel in a building can be significant, and the authorized personnel may need to move between the interior rooms multiple times throughout the day. Therefore, providing convenient and relatively unrestricted access to enter the building and move between the interior rooms is often an important design consideration that must be balanced with security measures to limit and/or prevent unauthorized access to the building or between interior rooms in the building.

The relatively large number of occupants in a building creates an increased threat that an armed person may access the building for criminal purposes. Although the capability exists to secure the building and interior rooms from unauthorized access, prompt communication throughout the building of an active threat is often not possible. As a result, several instances have been reported in which an armed shooter, such as a disgruntled student, an employee, or even a complete stranger, gained access to a school or office building and indiscriminately attacked personnel in multiple rooms before being stopped.

Therefore, the need exists for an improved security system for a building that can provide local and/or remote lockdown and/or monitoring capability for multiple doors in the building to promptly control access inside the building.

### BRIEF DESCRIPTION OF THE INVENTION

Aspects and advantages of the invention are set forth below in the following description, or may be obvious from the description, or may be learned through practice of the invention.

One embodiment of the present invention is a security system for a building. The security system includes a plurality of lock modules. Each lock module is associated with a particular door and has an unlocked position that allows the particular door to open and a locked position that prevents the particular door from opening. A lock bar associated with each lock module has a first position that allows the particular door associated with said lock module to open and a second position that prevents the particular door associated with said lock module from opening. An actuator associated with each lock module is operably connected to the lock bar associated with the lock module to move the lock bar associated with the lock module between the first and second positions. A sensor associated with each lock module determines a position of the particular door associated with the lock module and generates a door position signal that identifies if the particular door associated with the lock module is open or shut. A controller associated with each lock module and operably connected to the actuator and sensor associated with the lock module transmits a door status signal that reflects the door position signal. A lock module command signal received by the lock modules directs the lock modules to reposition to either the unlocked position or the locked position. Each controller enables the associated lock module to reposition to the locked position when the door position signal indicates the particular door associated with the lock module is shut.

An alternate embodiment of the present invention is a security system for a building. The security system includes a plurality of lock modules. Each lock module is associated with a particular door and has an unlocked position that allows the particular door to open and a locked position that prevents the particular door from opening. Each lock module includes a lock bar, an actuator, and a controller. The lock bar has a first position that allows the particular door associated with the lock module to open and a second position that extends from at least one of a door frame, a wall, or a floor surface adjacent to the particular door associated with the lock module to prevent the particular door associated with the lock module from opening. The actuator moves the lock bar between the first and second positions. The controller is operably connected to the actuator and transmits a door status signal that uniquely identifies the particular door associated with the lock module. A lock module command signal received by the plurality of lock modules directs the plurality of lock modules to reposition to either the unlocked position or the locked position.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of a lock module for a security system according to an embodiment of the present invention with the lock module in an unlocked position;

FIG. 2 is a perspective view of the lock module shown in FIG. 1 in a locked position;

FIG. 3 is a perspective view of the lock module shown in FIG. 2 with the cover removed; and

FIG. 4 is a functional block diagram of the security system according to an embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used in the claims, the definite article “said” identifies required elements that define the scope of embodiments of the claimed invention, whereas the definite article “the” merely identifies environmental elements that provide context for embodiments of the claimed invention that are not intended to be a limitation of any claim.

Embodiments of the present invention include a security system 10 for a building that provides local and/or remote lockdown and/or monitoring capability for multiple doors in the building to control access inside the building. The security system 10 includes a lock module 12 associated with each door 14 controlled by the security system 10. Each lock module 12 has an unlocked position that allows the associated door 14 to open and a locked position that prevents the associated door 14 from opening. As will be described, a controller 16 for each lock module 12 may generate a door status signal 18 and/or receive a lock module command signal 20. The door status signal 18 communicates information about the door 14 associated with the lock module 12, and the lock module command signal 20 directs the controller 16 to reposition the lock module 12 to either the locked or unlocked position.

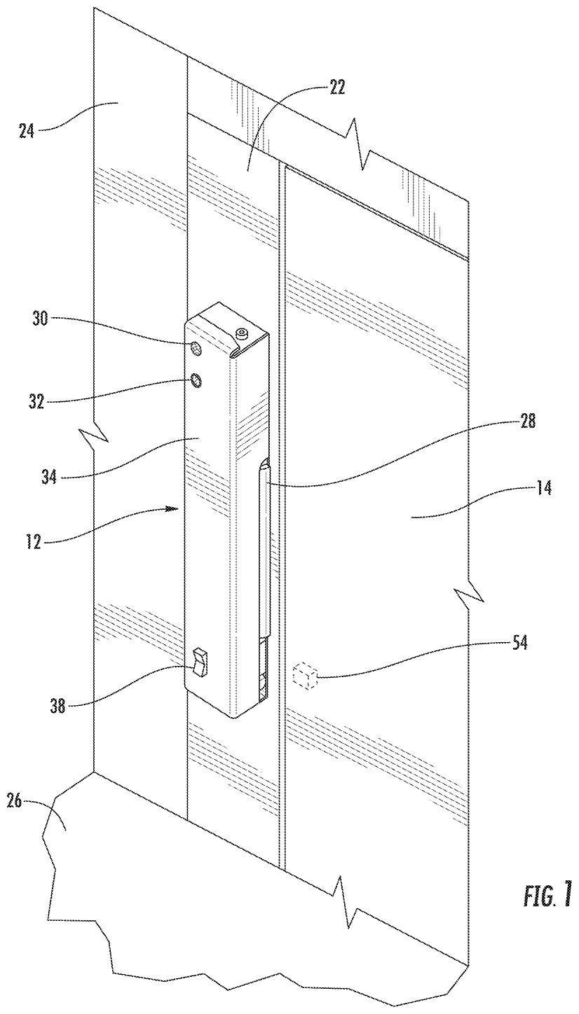

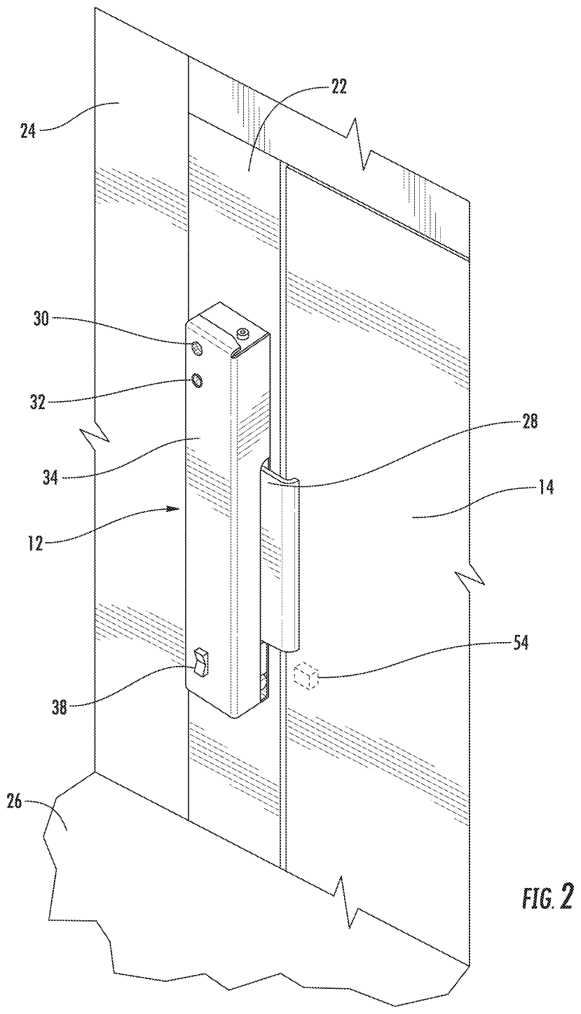

FIGS. 1 and 2 provide a perspective view of the lock module 12 in the unlocked and locked positions, respectively, according to an embodiment of the present invention. As shown in FIGS. 1 and 2, each lock module 12 may be attached to a door frame 22, a wall 24, or a floor surface 26 adjacent to the associated door 14. A lock bar 28 associated with each lock module 12 has a first or retracted position (FIG. 1) and a second or extended position (FIG. 2). The first or retracted position (FIG. 1) allows the door 14 associated with the lock module 12 to open, and the second or extended position (FIG. 2) prevents the door 14 associated with the lock module 12 from opening. Although illustrated as a plate that extends or retracts from the lock module 12, one of ordinary skill in the art will appreciate that the lock bar 28 may be a rod, a bolt, or other similar structure that extends from the door frame 22, wall 24, and/or floor surface 26 to prevent the door 14 from opening, and the present invention is not limited to any particular structure unless specifically recited in the claims.

As shown in FIGS. 1 and 2, the lock module 12 may further include additional, optional features to monitor local conditions and enhance functionality of the security system 10. For example, the lock module 12 may include a speaker 30 and/or an image sensor 32 visible through a cover 34 of the lock module 12. The speaker 30 may generate an audible signal to alert occupants when the controller 16 receives the lock module command signal 20 to direct the associated lock module 12 to reposition to the unlocked and/or locked positions. The image sensor 32 may be a camera or video recorder that captures images or video of the surrounding area and generates an image or video signal 36. The image sensor 32 may continually capture images or video or may be enabled to only capture images or video and/or generate the image or video signal 36 when the controller 16 receives the lock module command signal 20 to direct the associated lock module 12 to reposition to the unlocked and/or locked positions.

The lock module 12 may optionally include a manual arm/disarm switch 38 that allows local control of the lock module 12 and generates an arm/disarm signal 40 when actuated. The manual arm/disarm switch 38 may be separate buttons or combined into a single rocker switch as shown in FIGS. 1 and 2. In this manner, an operator may depress the arm/disarm switch 38 to reposition the associated lock module 12 to the locked or unlocked position regardless of the lock module command signal 20.

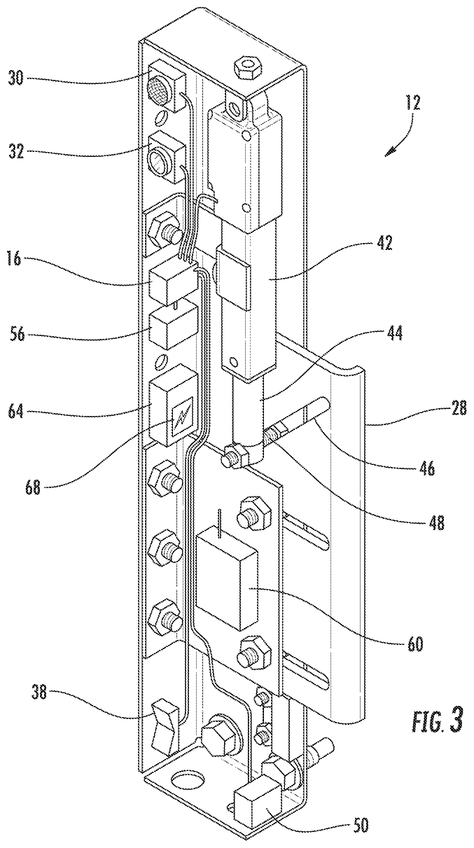

FIG. 3 provides a perspective view of the lock module 12 shown in FIG. 2 with the cover 34 removed. As shown in FIG. 3, an actuator 42 associated with the lock module 12 is operably connected to the lock bar 28 to move the lock bar 28 between the first or retracted position and the second or extended position. The actuator 42 may be any electrical, pneumatic, hydraulic, rotary, or geared device known in the art for moving the lock bar 28 between the first and second positions based on instructions 43 provided by the controller 16. As shown in FIG. 3, for example, the actuator 42 may include a reciprocating piston 44 connected by a follower 48 to a slot 46 in the lock bar 28. To move the lock bar 28 to the second or extended position, the controller 16 sends instructions 43 to the actuator 42 to extend the piston 44. As the piston 44 extends from the actuator 42, the follower 48 travels in the slot 46 to drive the lock bar 28 to the right, as shown in FIG. 3. To move the lock bar 28 to the first or retracted position, the controller 16 sends instructions 43 to the actuator to retract the piston 44. As the piston 44 retracts into the actuator 42, the follower 48 travels in the slot 46 to drive the lock bar 28 to the left.

Moving the lock module 12 to the locked position while the associated door 14 is open may actually lock the door 14 open or prevent the door 14 from being shut. Therefore, each lock module 12 may also include a sensor 50 that determines a position of the particular door 14 associated with the lock module 12 and generates a door position signal 52 that identifies if the particular door 14 is open or shut. The sensor 50 may be a proximity sensor that detects the presence or absence of the associated door 14 or a metallic object 54 in the door 14. The door position signal 52 may be used by the controller 16 as an interlock to prevent the actuator 42 from moving the lock bar 28 to the second or extended position when the door 14 is open.

An unauthorized visitor may attempt to physically breach the door 14 when the lock module 12 is in the locked position. As a result, each lock module 12 may also include a vibration sensor 56 that monitors the vibration level near the lock module 12 and generates a vibration signal 58 that reflects a level of vibration at the lock module 12.

Each lock module 12 may further include a modem 60, a status indicator 62, and a power distribution module 64. The modem 60 may transmit and receive information to and from the lock module 12 using cellular technology. For example, the modem 60 may receive the door status signal 18 from the controller 16 and transmit the door status signal 18 over a standard cellular network to other lock modules 12 in the security system 10. Alternately, or in addition, the modem 60 may receive the lock module command signal 20 from other lock modules 12 or the security system 10 and communicate the lock module command signal 20 to the controller 16 to reposition the lock module 12. The status indicator 62 may provide a local indication of the operability of the lock module 12. For example, the status indicator 62 may be an LED or visual display that indicates that the lock module 12 is receiving power, communicating with other lock modules 12, and available for operation. The power distribution module 64 may supply electricity from an external source 66 and/or internal battery 68 to the previously described components. In the event of loss of power from the external source 66, the power distribution module 64 may extend operation of each lock module 12 by selectively limiting power to components that are not directly associated with repositioning the lock module 12, such as the speaker 30, image sensor 32, and/or vibration sensor 56.

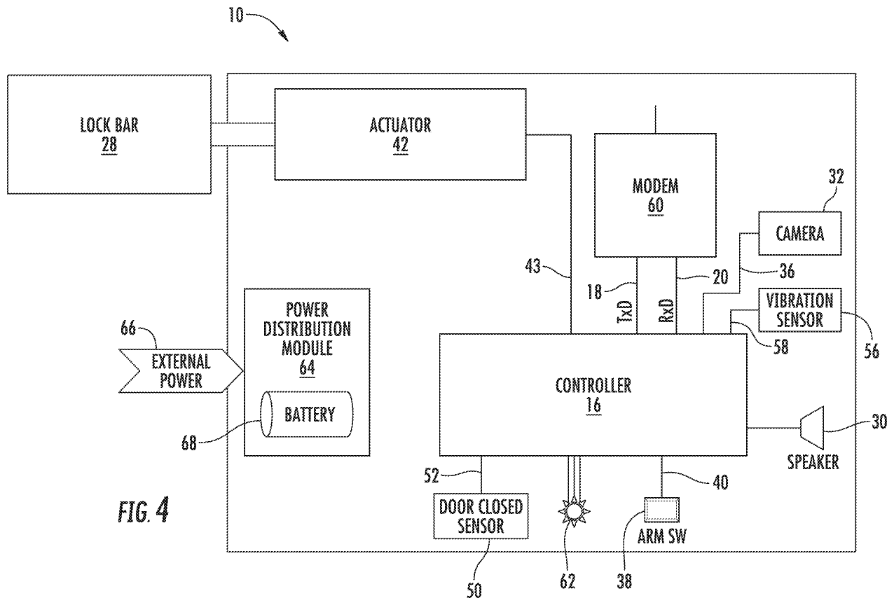

FIG. 4 provides a functional block diagram of the security system 10 to illustrate the integration of the previously described components with the controller 16 according to an embodiment of the present invention. As used herein, the controller 16 is not limited to any particular hardware architecture or configuration. The controller 16 may be one or more general purpose or customized computing devices adapted in any suitable manner to provide the desired functionality. The device(s) may be adapted to provide additional functionality complementary or unrelated to the present subject matter, as well. For instance, one or more computing devices may be adapted to provide desired functionality by accessing logic or software instructions rendered in a computer-readable form. When software is used, any suitable programming, scripting, or another type of language or combinations of languages may be used to implement the teachings contained herein. However, software need not be used exclusively, or at all. For example, some embodiments of the systems and methods set forth herein may also be implemented by hard-wired logic or other circuitry, including, but not limited to application-specific circuits. Of course, combinations of computer-executed software and hard-wired logic or other circuitry may be suitable, as well.

As shown in FIG. 4, the controller 16 may transmit the door status signal 18 to the modem 60 for communication over a cellular network to other lock modules 12 or the security system 10. In particular embodiments, the door status signal 18 may include a unique identifier for the particular door 14 associated with the lock module 12 to allow the security system 10 to identify each door 14 included in the system. Alternately, or in addition, the door status signal 18 may include a heartbeat protocol that indicates an operational status for the lock module 12. For example, the heartbeat protocol may include periodic pings between the processor 16 and the various components associated with each lock module 12 to confirm operability, and the door status signal 18 may include the results of this check. If desired, the heartbeat protocol may provide a basis for the security system 10 to generate the lock module command signal 20 to one or more lock modules 12. For example, the security system 10 may be configured to generate the lock module command signal 20 to reposition the lock modules 12 to locked in the event the heartbeat protocol indicates that any single lock module 12 is inoperable.

As shown in FIG. 4, each previously described component may also communicate information to the controller 16 to enable the controller 16 to properly respond to the lock module command signal 20 and/or for inclusion in the door status signal 18. For example, the sensor 50 may communicate the door position signal 52 to the controller 16 to prevent the controller 16 from repositioning the lock module 12 to the locked position when the door 14 is not shut. Upon receipt of a lock module command signal 20 that directs the lock module 12 to reposition to the locked position, the controller 16 may send instructions 43 to the actuator 42 to reposition the lock bar 28 only if the door position signal 52 indicates that the associated door 14 is already shut. Otherwise, the controller 16 may delay repositioning the lock module 12 until the door position signal 52 indicates that the associated door 14 is shut. In any event, the controller 16 may include the door position signal 52 in the door status signal 18 so other lock modules 12 and the security system 10 have accurate information about the position of each door 14 in the system.

The manual arm/disarm switch 38 may similarly communicate the arm/disarm signal 40 to the controller 16 to cause the controller 16 to provide instructions 43 to the actuator 42 to reposition the lock module 12. For example, an operator may use the arm/disarm switch 38 to locally reposition the lock module 12 to the locked position. The controller 16 may also incorporate the arm/disarm signal 40 into the door status signal 18 for communication to other lock modules 12 or the security system 10. In this manner, the other lock modules 12 and/or security system 10 may propagate the arm/disarm signal 40 throughout the security system 10 using the lock module command signal 20 to similarly reposition all lock modules to the locked position.

As previously discussed, the image or video signal 36 may include images or video of the surrounding area, and the image sensor 32 may communicate this image or video signal 36 to the controller 16. Similarly, the vibration sensor 56 may communicate the vibration signal 58 to the controller 16. The controller 16 may in turn incorporate the image or video signal 36 and/or the vibration signal 58 into the door status signal 18 for transmission by the modem 60 to the security system 10. In this manner the security system 10 may receive the images, video, and/or vibration levels of the surrounding area for any lock modules 12 included in the system.

One of ordinary skill in the art will readily appreciate that the embodiments described and illustrated in FIGS. 1-4 may thus provide an improved security system for a building that allows doors 14 included in the system to be remotely or locally locked. In addition, the status of each lock module 12, position of each door 14, and visual and physical conditions near each door 14 may be communicated throughout the security system 10 to enhance situational awareness and response time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A security system for a building, comprising:
a plurality of lock modules, wherein each lock module is associated with a particular door and has an unlocked position that allows the particular door to open and a locked position that prevents the particular door from opening;
a lock bar associated with each lock module, wherein each lock bar has a first position that allows the particular door associated with said lock module to open and a second position that prevents the particular door associated with said lock module from opening;
an actuator associated with each lock module, wherein each actuator is operably connected to said lock bar associated with said lock module to move said lock bar associated with said lock module between said first and second positions;
a sensor associated with each lock module, wherein each sensor determines a position of the particular door associated with said lock module and generates a door position signal that identifies if the particular door associated with said lock module is open or shut;
a controller associated with each lock module and operably connected to said actuator and said sensor associated with said lock module, wherein each controller transmits a door status signal that reflects said door position signal;
a lock module command signal received by said plurality of lock modules, wherein said lock module command signal directs said plurality of lock modules to reposition to either said unlocked position or said locked position; and
wherein each controller enables said associated lock module to reposition to said locked position when said door position signal indicates the particular door associated with said lock module is shut.

2. The security system as in claim 1, wherein each lock module is attached to at least one of a door frame, a wall, or a floor surface adjacent to the particular door associated with each lock module.

3. The security system as in claim 1, wherein said door status signal for said associated lock module further includes a unique identifier for the particular door associated with said lock module.

4. The security system as in claim 1, wherein said door status signal for said associated lock module further includes a heartbeat protocol that indicates an operational status for said lock module.

5. The security system as in claim 1, further comprising a vibration sensor associated with each lock module, and said door status signal for said associated lock module includes a vibration signal that reflects a level of vibration at said lock module.

6. The security system as in claim 1, further comprising an image sensor associated with each lock module, said image sensor activates when said lock module command signal directs said associated lock module to reposition to said locked position, and said door status signal for said associated lock module includes at least one of an image or a video of an area at said lock module.

7. The security system as in claim 1, further comprising a manual arm switch associated with each lock module, said manual arm switch repositions said associated lock module to said locked position, and said door status signal for said associated lock module further identifies when said manual arm switch has been operated.

8. The security system as in claim 1, further comprising a manual disarm switch associated with each lock module, said manual disarm switch repositions said associated lock module to said unlocked position, and said door status signal for said associated lock module further identifies when said manual disarm switch has been operated.

9. The security system as in claim 1, further comprising a speaker associated with each lock module, and said speaker generates an audible signal when said lock module command signal directs said associated lock module to reposition to at least one of said unlocked position or said locked position.

10. A security system for a building, comprising:
a plurality of lock modules, wherein each lock module is associated with a particular door and has an unlocked position that allows the particular door to open and a locked position that prevents the particular door from opening, and each lock module comprises:
a lock bar having a first position that allows the particular door associated with said lock module to open and a second position that extends from at least one of a door frame, a wall, or a floor surface adjacent to the particular door associated with said lock module to prevent the particular door associated with said lock module from opening;
an actuator that moves said lock bar between said first and second positions;
a controller operably connected to said actuator, wherein said controller transmits a door status signal that uniquely identifies the particular door associated with said lock module;
a lock module command signal received by said plurality of lock modules, wherein said lock module command signal directs said plurality of lock modules to reposition to either said unlocked position or said locked position.

11. The security system as in claim 10, wherein said door status signal further identifies if the particular door associated with said lock module is open or shut.

12. The security system as in claim 11, wherein said controller enables said actuator to move said lock bar associated with said lock module to said second position when said door status signal for said lock module indicates the particular door associated with said lock module is shut.

13. The security system as in claim 10, wherein said door status signal further includes a heartbeat protocol that indicates an operational status for said lock module.

14. The security system as in claim 10, wherein each lock module further comprises a vibration sensor, and said door status signal further includes a level of vibration at said lock module.

15. The security system as in claim 10, wherein each lock module further comprises an image sensor that activates when said lock module command signal directs said lock module to reposition to said locked position, and said door status signal for said lock module includes at least one of an image or a video of an area at said lock module.

16. The security system as in claim 10, wherein each lock module further comprises a manual arm switch that repositions said lock module to said locked position, and said door status signal for said lock module identifies when said manual arm switch has been operated for said lock module.

17. The security system as in claim 10, wherein each lock module further comprises a manual disarm switch that repositions said lock module to said unlocked position, and said door status signal for said lock module identifies when said manual disarm switch has been operated for said lock module.

18. The security system as in claim 10, wherein each lock module further comprises a speaker that generates an audible signal when said lock module command signal directs said lock module to reposition to at least one of said unlocked position or said locked position.
